(19) United States
(12) Patent Application Publication
(10) Pub. No.: US 2026/0162001 A1
(43) Pub. Date: Jun. 11, 2026

(54) SYSTEM AND METHOD FOR REDUCING INFERENCE LATENCY OF A CONTAINERIZED MACHINE LEARNING MODEL

(71) Applicant: ACTIMIZE LTD., Ra'anana (IL)

(72) Inventors: Shailesh KULKARN, Pune Maharashtra (IN); Pratik GOENKA, Pune Maharashtra (IN); Mayur SONKAMBLE, Aurangabad (IN); Manohar PATIL, Pune Maharashtra (IN)

(21) Appl. No.: 18/973,000

(22) Filed: Dec. 8, 2024

(51) Int. Cl. G06N 20/00

(52) U.S. Cl. CPC G06N 20/00

(57) ABSTRACT

A computerized-method for reducing inference latency of a containerized ML model. The computerized-method includes: (i) training an ML model on a plurality of raw features and derived features, and creating a trained ML model object; (ii) operating transformation metadata extraction for each derived feature to generate a transformation-metadata file; (iii) converting the transformation-metadata to a programming language code to yield a performant code; (iv) executing the performant code by the trained ML object to generate derived features; (v) packaging the trained ML model object and the yielded performant code by operating a model containerization service to create an ML model container image of the containerized ML model to be stored in a container registry; and (vi) configuring a platform that provides a model-hosting-service to run the ML model container image and apply the performant code on features in a request from a features management-platform to provide a calculated score.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of machine learning models in fraud detection and more specifically to data transformations during inference of the machine learning models.

### BACKGROUND

Systems in Financial Institutes (FI)s require executing Machine Learning (ML) models for each transaction to detect fraud by acquiring a risk score. This risk score is used for determining if the transaction is to be treated as fraudulent. The transaction risk score has to be generated with low latency so that the overall service level for processing a real-time transaction is achieved.

Creating feature values at the time of inference of the ML model involves applying the same data transformations to new data points as were applied during the training phase. This ensures that the ML model receives data in the same format and scale it was trained on. The data transformation should be consistent, e.g., normalization and encoding. Feature engineering requires that any features derived from existing data, such as date-time features, like day of the week, is computed in the same manner and features that involves aggregations is recalculated using the same window sizes and methods.

The executed ML model performs data transformations to create feature values at the time of inference, which are then used to calculate the risk score. Commonly, ML models for fraud detection are created using Python® libraries. The ML models are then containerized to execute in real time as part of the transaction processing.

Data transformation contributes to data quality improvement, compatibility, and feature engineering. It involves converting raw data into a format that is more suitable for analysis and model training by various techniques, such as handling missing data, normalization, standardization, encoding categorical data and dealing with outliers.

Some data transformations are integrated into the ML model pipeline, allowing for dynamic adjustments during training and prediction. The majority of the latency of the ML models is contributed by data transformation, i.e., calculation of feature value that is implemented by data wrappers, e.g., Pandas, that have been used during the training phase of the ML model. However, these data wrappers, that have been used during training, are not efficient in production environment when processing a single record of the data used in inference for fraud detection.

Data wrappers are tools or libraries that provide a consistent interface for interacting with different types of data sources or formats. Data wrappers handle different input formats by providing a consistent interface for data preprocessing and transformation. They abstract the complexities of data handling, making it easier to preprocess, transform, and feed data into ML models. For example, a data wrapper might convert various input formats into a common format that the ML model can understand.

The containerized ML model that has been created using legacy ML model building pipeline takes about 40-60 milliseconds to provide the inference with the risk score. However, this latency may be unacceptable for the financial institutes as it negatively impacts the transaction processing service levels.

Accordingly, there is a need for a technical solution that will separate the ML model training and inference methodology to reduce inference latency of the containerized ML models by replacing the data wrappers used during training phase of the ML model with efficient functions without compromising the ML model accuracy of the risk score.

Thus, the required technical solution may improve the performance for ML model inference by carrying out transformations via efficient code in lower latency, e.g., single digit milliseconds, without compromising the ease of ML model development and training with data wrappers by the data scientist.

### SUMMARY

There is thus provided, in accordance with some embodiments of the present disclosure, a computerized-method for reducing inference latency of a containerized Machine Learning (ML) model.

Furthermore, in accordance with some embodiments of the present disclosure, the computerized-method may include: (i) training an ML model on a plurality of raw features which are stored in a feature database and a plurality of derived features and creating a trained ML model object; (ii) operating transformation metadata extraction for each derived feature in the plurality of derived features to generate a transformation-metadata file. The transformation-metadata file includes transformation-metadata; (iii) converting the transformation-metadata in the transformation-metadata file to a programming language code to yield a performant code; (iv) executing the performant code by the trained ML object to generate derived features; (v) packaging the trained ML model object and the yielded performant code by operating a model containerization service to create an ML model container image of the containerized ML model to be stored in a container registry; and (vi) configuring a platform that provides a model-hosting-service to run the ML model container image and apply the performant code on features in a request from a features management-platform to provide a calculated score to the features management-platform.

Furthermore, in accordance with some embodiments of the present disclosure, the transformation metadata extraction may include: (i) selecting raw features from the plurality of raw features and derived features; (ii) determining one or more feature-calculations on the selected raw features to create derived features. The one or more feature-calculations are the transformation metadata for the raw feature; and (iii) generating the transformation-metadata file with the determined one or more feature-calculations on the selected raw features.

Furthermore, in accordance with some embodiments of the present disclosure, the calculated score may be a risk score of a financial transaction. The features management-platform may be a fraud risk management-platform.

Furthermore, in accordance with some embodiments of the present disclosure, the platform that provides model hosting service may be one of: cloud services, managed container services and Kubernetes cluster. The containerized ML model image may be deployed as a pod in the Kubernetes cluster.

Furthermore, in accordance with some embodiments of the present disclosure, the calculating of the score may be operated by the trained ML object by using the selected raw features and the created derived features.

Furthermore, in accordance with some embodiments of the present disclosure, the fraud risk management-platform may invoke the ML model container image to run during a financial transaction processing.

### BRIEF DESCRIPTION OF THE DRAWINGS

FIG. 1 schematically illustrates a model building pipeline, in accordance with some embodiments of the present disclosure;

FIGS. 2A-2B are a high-level workflow of a computerized-method for reducing inference latency of a containerized Machine Learning (ML) model, in accordance with some embodiments of the present disclosure;

FIG. 3 schematically illustrates utility for converting transformation metadata to low latency, in accordance with some embodiments of the present disclosure;

FIG. 4 is a high-level workflow of converting metadata into low latency code, in accordance with some embodiments of the present disclosure;

FIG. 5 schematically illustrates a software design for automated deployment for containerized model, in accordance with some embodiments of the present disclosure;

FIG. 6 is a high-level workflow of real-time model inference for fraud detection, in accordance with some embodiments of the present disclosure;

FIGS. 7A-7B are screenshots of an Application Programming Interface (API) testing tool showing a calculated score and time required to calculate it, in accordance with some embodiments of the present disclosure;

FIG. 8 illustrates a transaction journey in a process of fraud detection, in accordance with some embodiments of the present disclosure;

FIG. 9 is a screenshot of a UI displaying a list of alerts, in accordance with some embodiments of the present disclosure; and

FIG. 10 is a screenshot of a UI displaying details of an alert, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

ML models are created by data scientists who commonly focus on creating the ML model which embeds data transformations and ML model processing. Only a small portion of Machine Learning (ML) models are required to produce inference in single digit milliseconds response time.

Existing ML model creation techniques use same approach for data transformation for ML model training as well as inference. This approach slows down performance during inference.

During inference from the ML model container, a calculation of the feature values and risk score using the feature values may be operated. Majority of the latency of the ML model inference is contributed by calculation of feature values, as these feature values are calculated using same data wrapper, e.g. pandas, which are used for training the ML model. These data wrappers are not efficient performant with single record of the data used during inference for fraud detection.

Therefore, there is a need for a technical solution that will replace the use of data wrappers with programming language functions which will perform efficiently with a single data database record.

There is a need for system and method for reducing inference latency of a containerized Machine Learning (ML) model.

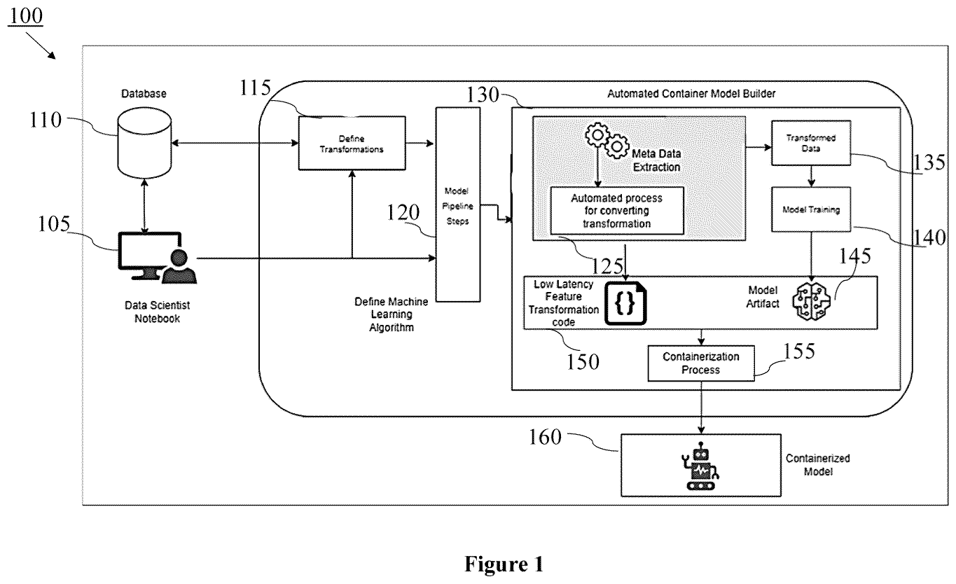

FIG. 1 schematically illustrates a model building pipeline 100, in accordance with some embodiments of the present disclosure.

According to some embodiments of the present disclosure, a user, such as data scientist or a model developer may open a model development environment, such as Jupyter® Notebook and access the feature database 110. This database 110 may consist of the historical financial transactions details, such as transaction amount, transaction date, mode of transaction and the like. The database may also have a flag which may indicate if a transaction was determined to be fraud or legit. All these features may be captured and stored by an Integrated Fraud Management (IFM) system in the database 110.

According to some embodiments of the present disclosure, the IFM system is a real-time, end-to-end fraud prevention platform. The IFM invokes the ML model during the financial transaction processing. The IFM helps Financial Institutions (FI) to detect, prevent, and mitigate fraud across multiple sectors including banking, insurance, and fintech. For example, it may run on a computer, which is an Application Interface Services (AIS) Server.

According to some embodiments of the present disclosure, data related to the financial transaction that is processed may be stored in a transactions database. For example, a relational database may store the data related to the financial transaction and the calculated risk score by the ML model. For example, the hardware that is runs may be a database hosted on MSSQL® or Oracle® DB server with Linux Operating System (OS).

According to some embodiments of the present disclosure, the user may retrieve the features data on the notebook. Then, the user may define transformations 115 by using model building pipeline steps used to create derived features. The raw features and the derived features are then used as a dataset to train the ML model. To create the derived features, the user may define simple or complex transformations in the pipeline steps using an underlying language, such as Python® and data wrappers, such as Python's library Pandas®.

According to some embodiments of the present disclosure, the transformation can be any type of calculation, such as difference between two dates or ratio of two amounts and the like. These transformations may be used for both ML model development on thousands of transactions and also in the ML model inference on each current transaction that is going through the IFM system for fraud prediction.

According to some embodiments of the present disclosure, the transformation code may be captured and stored along with the ML model artifacts, which are the outputs generated from training the ML model. However, using the stored transformation code from the ML model development stage, as defined by the user, may increase latency of the ML model inference because, data wrappers, such as Python's library Pandas, may be useful for transforming thousands of transaction records for the ML model training, but they induce significant latency on a single transaction data during the ML model inference.

According to some embodiments of the present disclosure, the user may define post transformation definition, the appropriate ML algorithm, such as XG Boost, and input and target features and may add it to model pipeline steps 120.

According to some embodiments of the present disclosure, the ML model training pipeline may be a framework which allows users to chain multiple ML processing steps to create a ML model. It allows wrapping a sequence of multiple ML training stages and ML algorithms in one object. Typically, ML Model training pipelines are built leveraging existing frameworks, such as Scikit learn. These pipelines help data scientists to create the ML model in a systematic and organized manner. After completion of the required stages of the ML model training pipeline, a trained model object is created. The ML model training pipeline may run on a computer running Linux OS.

According to some embodiments of the present disclosure, the data transformation steps, and the defined ML algorithm may be provided to a container model builder 130. An automated process for converting transformation 125 within the container model builder 130 may extract the transformation metadata. This metadata may include information of the transformation that has been applied, for example, difference or ratio, the raw features that the transformation is being applied on, conditions if any and the like.

According to some embodiments of the present disclosure, the metadata may be for example,

Enrichment Double DATE_DIFF if clientAddressUpdateDate == ( −999.01 || TransactionDateTime
== −999.01 ) { −999.01 } else { dateDiff(Day, toDate(clientAddressUpdateDate). “yyyy-MM-dd
HH:mm:ss”), toDate(transactionNormalizedDateTime), “yyy-MM-dd HH:mm:ss”)) } 0

According to some embodiments of the present disclosure, the ML model training may be separated from the inference methodology, such that instead of using the same methodology, as the training has been operated on multiple financial transactions, the ML model inference may operate on a single financial transaction, e.g., single database record. Transformation metadata refers to the information that describes the processes and transformations applied to data as it moves through various stages. This type of metadata is crucial for understanding how data has been altered from its original state to its current form.

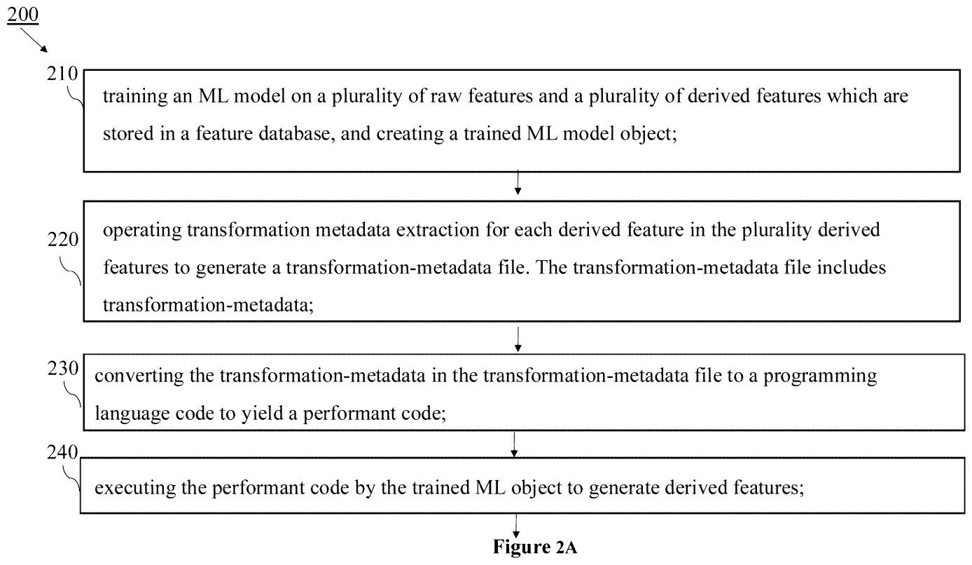

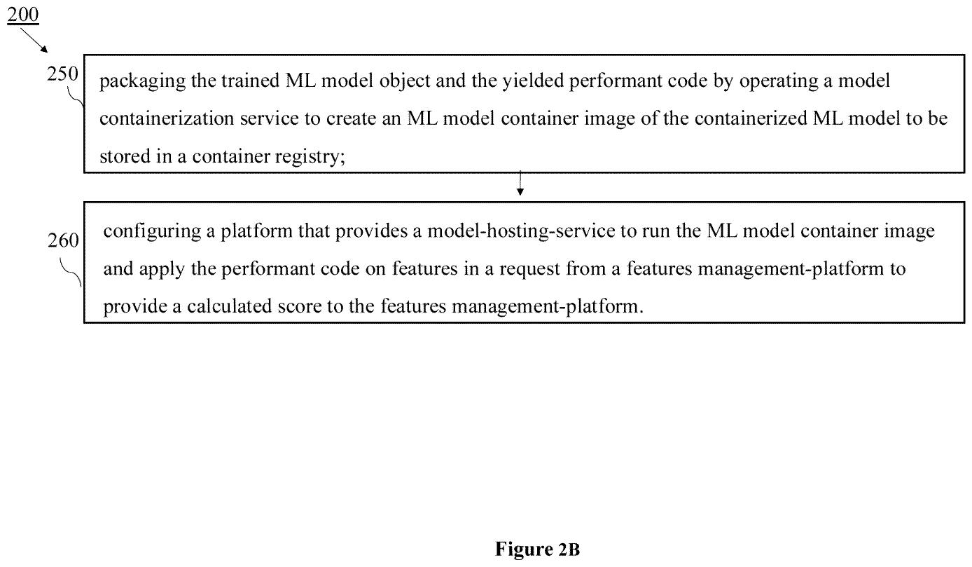

According to some embodiments of the present disclosure, the computerized-method for reducing inference latency of a containerized ML model, such as computerized-method for reducing inference latency of a containerized ML model 200 in FIG. 2, may replace the use of data wrappers with functions of a programming language, such as Python® functions, which may perform efficiently with a single database record.

According to some embodiments of the present disclosure, because the ML model training needs to be performed using data wrappers, an automated system may convert the data wrapper specific operations into more efficient programming language functions without data wrappers. The automated system may ensure that the ML model's accuracy is not compromised due to replacing data wrappers with which the ML model is trained. It ensures that by using the same functions as used in data wrappers by using function mapping. The function mapping is used by the metadata converter tool. The functionality of the functions used in data wrappers is compatible with their respective counter parts in the programming language.

According to some embodiments of the present disclosure, the containerized model 160, that has been created by the model building pipeline 100, may run during the ML model inference in a reduced latency for fraud detection by converting the data transformation code for creating features at the time of inference to a programming language functions, such as Python® code, which runs faster at the time of inference to yield transformed data 135. The transformed data 135 is the training dataframe of raw features and derived features that are used for the ML model training.

According to some embodiments of the present disclosure, the container model builder 130 may generate ML model training data which may include the raw features and the derived features which were created using transformations. This training data may be used to train the ML model. Training the ML model on a plurality of raw features which are stored in a feature database and a plurality of derived features and creating a trained ML model object.

According to some embodiments of the present disclosure, the raw features which are stored in a feature database and the derived features may be in required format such that it can be easily accessed by the data scientists who are using e.g., ML Studio for training the ML model. For example, it may run on a database and may be hosted on a valid version of MSSQL® or Oracle® DB server with Linux operating system. The data scientists take the raw data and calculate the derived features in the feature database to create the training dataset for training the ML model. This feature database is enriched periodically with incremental raw data/features. Typically, thousands of records are part of the training dataset for the ML model. Tens of features are typically required as an input to the ML model for calculating the risk score.

According to some embodiments of the present disclosure, the derived features may be created by applying transformation on the raw features. The raw features and the derived features may be kept as dataframe that is stored on the model development environment instance.

According to some embodiments of the present disclosure, the ML Studio for training the ML model may have a client, which is a User Interface (UI) for integrated development environment for building, training, deploying machine learning models and it is typically used by data scientists. It provides an integrated suite of tools and capabilities to streamline the entire ML workflow. For example, it may run on a computer via internet browsers, such as Google Chrome®, Mozilla Firefox®, MS Edge®, Safari and the like. The ML Studio server may be a backend component for integrated development environment for building, training, and deploying ML models. It provides the backend for handling tasks, such as running code cells, managing kernels, running the machine learning model training, executing the utilities to create ML model artefacts etc. For example, the hardware it runs may be computer/VM running a Linux OS with a JVM.

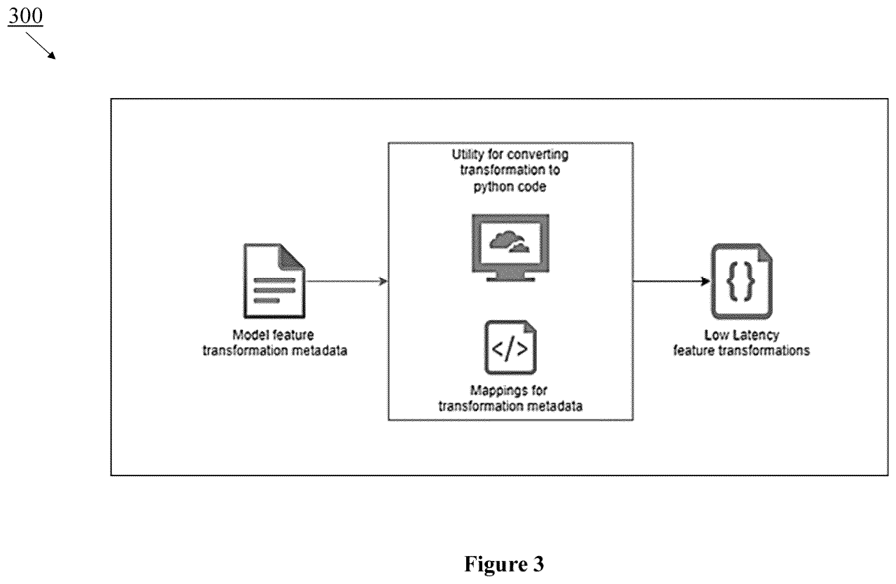

According to some embodiments of the present disclosure, the transformation metadata extracted by the automated process for converting transformation 125, e.g., metadata converter utility may be used to generate the low latency transformation code 150 in a programming language, such as Python®. For example, as shown in FIG. 3.

According to some embodiments of the present disclosure, operating transformation metadata extraction for each derived feature in the plurality derived features to generate a transformation-metadata file. The hardware that the extraction may run on may be for example, computer running a Linux Operating System (OS) with Java Virtual Machine (JVM). The transformation-metadata file may include the transformation-metadata and may be stored in different formats, such as JavaScript Object Notation (JSON) or Comma-Separated Values (CSV). Then the metadata that is stored in such a format may be converted into a programming language, such as Python®.

According to some embodiments of the present disclosure, the transformation-metadata may be for example,

val DATE_DIFF: Any = if (modelInput.get(“clientAddressUpdateDate”) == −999.01 ||
modelInput.get (“transactionDateTime”) ==== −999.01 ) { −999.01 } else { dateDiff (Day,
toDate(modelInput.get(“clientAddressUpdateDate”), “yyyy-MM-dd HH:mm:ss”),
toDate(modelInput.get(“transactionDateTime”), “yyyy-MM-dd HH-mm:ss”)) }

According to some embodiments of the present disclosure, the ML model may be trained automatically using data from the transformed data 135 and the ML algorithm as defined by the user 105. The transformed data 135 is the training dataframe of raw features and derived features that is used for the ML model training.

According to some embodiments of the present disclosure, model artifacts 145, which are the outputs generated from training an ML model and may include weights and biases that the ML model has learned during training, description of the ML model architecture, including the layers and their configurations and training configuration, hyperparameters, and environment details may be exported in a serialized format, such as pickle file having complex data structures converted into a binary format that can be stored or transmitted over a network. The transformation-metadata in the transformation-metadata file may be converted to a programming language code to yield a performant code.

According to some embodiments of the present disclosure, the extraction of the transformation metadata may include selecting raw features from the plurality of raw features and then determining one or more feature-calculations on the selected raw features to create derived features. The one or more feature calculations may be the transformation metadata for the raw feature. The transformation-metadata file may be generated with the determined one or more feature-calculations on the selected raw features. The raw features may be selected based on annotated features by a user such as data scientist at the time of the ML model training.

According to some embodiments of the present disclosure, the model containerized process 155 may combine low latency code from the low latency feature transformation code 150 and the model artifacts 145 in a single model container image of the containerized model 160. Containerization involves packaging the ML model along with its dependencies, libraries, and configuration files into a container. This container can then be deployed consistently across different environments, ensuring that the model runs the same way regardless of where it's executed. For example, Docker may be used as a tool for this purpose.

According to some embodiments of the present disclosure, the model container image of the containerized model 160 may perform the ML model inference in a reduced latency when implemented in an IFM system.

According to some embodiments of the present disclosure, the performant code may be executed by the trained ML object to generate derived features. The trained ML model object and the yielded performant code may be packed, by operating a model containerization service, to create the ML model container image of the containerized ML model 160 which may be stored in a container registry. The ML model container image may be a packaged environment that includes elements which are required to run the ML model, the trained ML model, dependencies and libraries necessary to run the model, configuration settings needed for the ML model and the code to load and serve the ML model.

According to some embodiments of the present disclosure, the model containerization service may be an automated packaging service which containerizes ML model object and performant code for feature transformations to create the ML model container image of the containerized model 160. The model containerization service allows packaging a ML model developed in a lab environment in a container, e.g. Docker container and adding it to container registry. The ML model container, e.g., the containerized ML model is created combining the ML model object with the python/other language code and creating the container image. This containerization process is typically driven by data scientists. They produce the container image for the ML model and store it in the container registry. The container exposes a Representational State Transfer (REST) Application Programming Interface (API) for executing the ML model and may be used in the runtime environment. The ML model image can be hosted on the different possible compute, e.g. Kubernetes for carrying out the inferences at scale using resilient infrastructure.

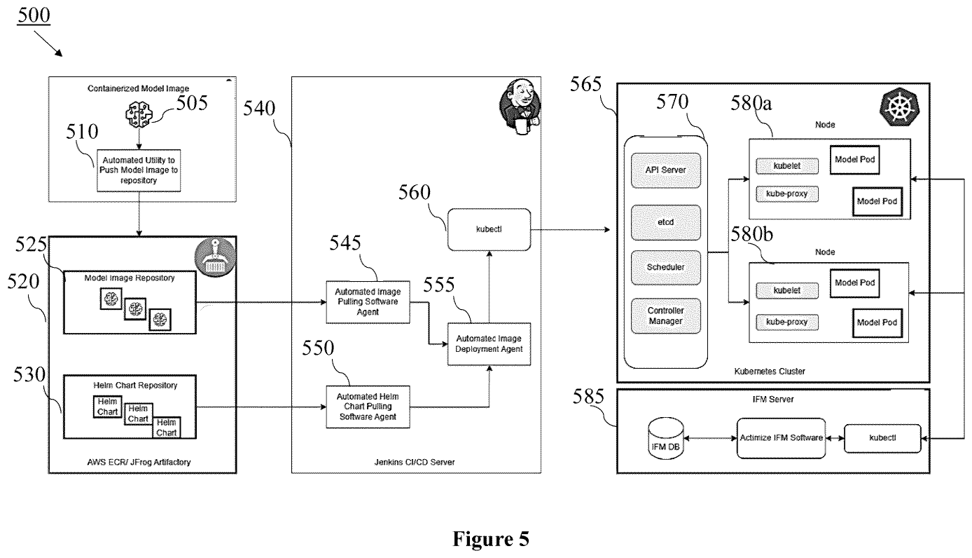

According to some embodiments of the present disclosure, a platform that provides a model-hosting-service may be configured to run the ML model container image and apply the performant code on features in a request from a features management-platform to provide a calculated score to the features management-platform. The platform that provides model hosting service may be one of: cloud services, managed container services and Kubernetes cluster, as shown in element 565 in FIG. 5. The containerized ML model image may be deployed as a pod in the Kubernetes cluster. The Kubernetes is a set of node machines for running containerized applications.

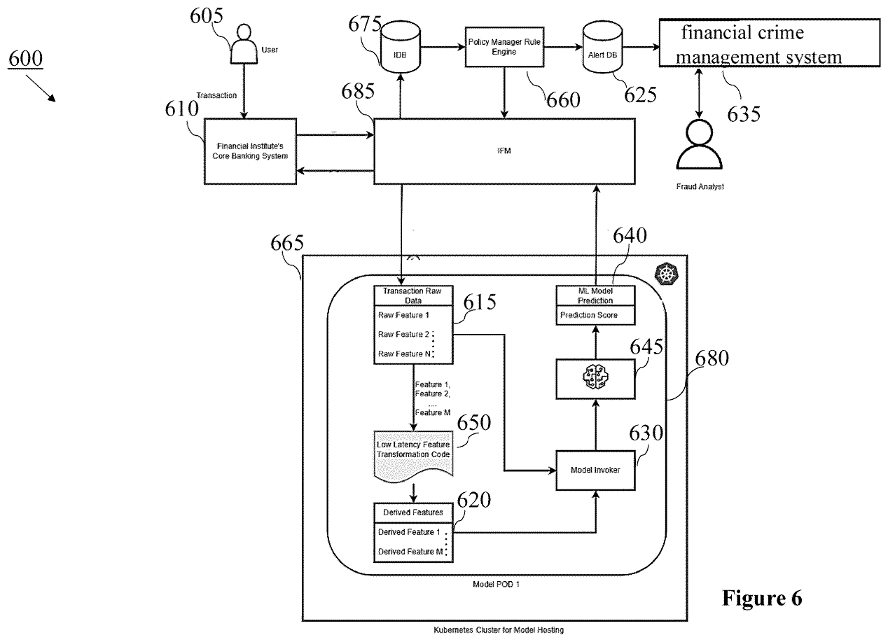

According to some embodiments of the present disclosure, the platform that provides a model-hosting-service provisions the necessary hardware and software resources to host ML models in a highly scalable and available manner. It provides inference from the ML model, manages the requests and responses for getting the prediction score, e.g., risk score for the financial transactions. It manages the resources required for running one or more instances of the ML model, receives requests for calculation of risk scores from fraud risk management platform, such as IFM 685 in FIG. 6 and provides the response with the prediction score. The prediction score is calculated using the features received in the request body from the client. It is preferred to be a cluster running the containers, e.g. Kubernetes.

According to some embodiments of the present disclosure, the calculating of the score may be operated by the trained ML object by using the selected raw features and the created derived features.

According to some embodiments of the present disclosure, the calculated score may be a risk score of a financial transaction, and the features management-platform may be a fraud risk management-platform.

According to some embodiments of the present disclosure, the fraud risk management-platform may invoke the ML model container image of the containerized model 160 to run during a financial transaction processing. When the calculated risk score may be above a predefined threshold the financial transaction may be automatically stopped and forwarded to further investigation by a fraud analyst expert.

FIGS. 2A-2B are a high-level workflow of a computerized-method for reducing inference latency of a containerized Machine Learning (ML) model, in accordance with some embodiments of the present disclosure.

According to some embodiments of the present disclosure, operation 210 comprising training an ML model on a plurality of raw features which are stored in a feature database and a plurality of derived features and creating a trained ML model object.

According to some embodiments of the present disclosure, operation 220 comprising operating transformation metadata extraction for each derived feature in the plurality derived features to generate a transformation-metadata file. The transformation-metadata file includes transformation-metadata.

According to some embodiments of the present disclosure, operation 230 comprising converting the transformation-metadata in the transformation-metadata file to a programming language code to yield a performant code

According to some embodiments of the present disclosure, operation 240 comprising executing the performant code by the trained ML object to generate derived features

According to some embodiments of the present disclosure, operation 250 comprising packaging the trained ML model object and the yielded performant code by operating a model containerization service to create an ML model container image of the containerized ML model to be stored in a container registry.

According to some embodiments of the present disclosure, operation 260 comprising configuring a platform that provides a model-hosting-service to run the ML model container image and apply the performant code on features in a request from a features management-platform to provide a calculated score to the features management-platform.

FIG. 3 schematically illustrates utility for converting transformation metadata to low latency 300, in accordance with some embodiments of the present disclosure.

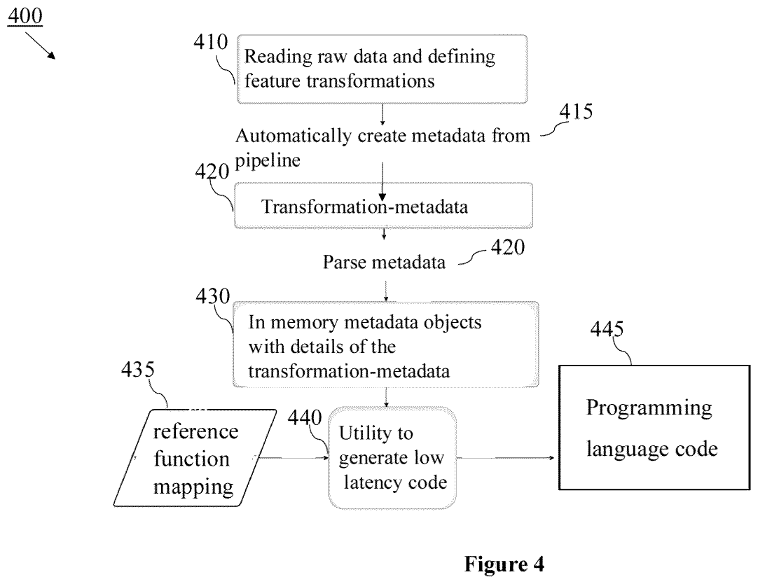

According to some embodiments of the present disclosure, the utility for converting transformation metadata to low latency 300 process may use model feature transformation metadata. A utility for converting the model feature transformation metadata to a programming language, such as Python® may be operated by a metadata converter tool, as shown in FIG. 3 and FIG. 4, to create mappings for the model feature transformation metadata to the programming language. Thus, yielding low latency feature transformations during the ML model inference, for example, as shown in FIG. 4

According to some embodiments of the present disclosure, the utility for converting transformation metadata to high performant code, such as utility to generate low latency code 440 in FIG. 4, may be an automated process to convert model feature transformation metadata to Python® or other programming language code. The reason for converting this metadata to python/programming languages code is to generate the high performant code which may enable low latency at the time of ML model inference. The code generated by this utility is performant because it does not require additional data wrappers, e.g. pandas for performing the calculations at the time of inference. The utility may run on a computer running Linux OS.

According to some embodiments of the present disclosure, the metadata converter tool may convert the transformation metadata to the programming language, e.g., high-performance code, by iterating on all transformation metadata rows of the feature and for each transformation metadata row extracting information from the expression in the transformation metadata row. The extracting may be operated, for example, by implementing Regular Expressions (RegEx), which are sequences of characters that form search patterns and used for string matching, searching, and manipulation.

According to some embodiments of the present disclosure, for example, the following record may represent a transformation metadata row.

{
Block_Name” : “MissingSubstitution”,
“Var_Type” : “Double”,
“Var_Name” : “requestedAmountNormalizedCurrency_MISS”,
“Expression” : “if (missing(modelInput.get(\“requestedAmountNormalizedCurrency\”))) { −999.01 }
else { modelInput.get(\“requestedAmountNormalizedCurrency\”) }”,
“Output_Type” : “Double”
}

According to some embodiments of the present disclosure, in the example, the extracted Expression value is:

“if (missing(modelInput.get(\“requestedAmountNormalizedCurrency\”))) { −999.01 } else {
modelInput.get(\“requestedAmountNormalizedCurrency\”) }”

According to some embodiments of the present disclosure, the metadata converter tool may extract the ‘condition value’, and the ‘truth value’ and ‘false value’, for example, by using RegEx. The ‘condition value’ in the example is missing(modelInput.get(“requestedAmountNormalizedCurrency”)), the ‘truth value’ is −999.01 and the ‘false value’ is modelInput.get(“requestedAmountNormalizedCurrency”).

According to some embodiments of the present disclosure, the metadata converter tool may get function name and raw feature name, for example, by using RegEx. The function name in the example is “missing” and the raw feature name is “requestedAmountNormalizedCurrency”. Then, the metadata converter tool may put together all the extracted values of ‘condition’, ‘truth value’, ‘false value’, ‘function name’ and ‘raw feature name’ to generate the high performance code.

According to some embodiments of the present disclosure, the metadata converter tool may generate the high-performance code by replacing the function name “missing” in corresponding function name in the programming language, for example, based on preconfigured mapping. [LL-please confirm] Based on a preconfigured structure, the raw feature name may be set to be equal to the ‘truth value’ if ‘condition value’ else ‘false value’. For example,
   $$derived_field_name$$=$$truth_value$$ if $$condition$$ else $$false_value$$.

According to some embodiments of the present disclosure, in the example, the extracted Expression value is:

requestedAmountNormalizedCurrency_MISS = −999.01 if
Util.missing(modelInput.get(“requestedAmountNormalizedCurrency”))
else
modelInput.get(“requestedAmountNormalizedCurrency”) .

According to some embodiments of the present disclosure, the ML model training takes place on a high volume of raw data. For this purpose, data wrappers are used. However, making use of these wrappers on a single record during the model inference is counterproductive and slows down the calculations for transformation in real-time operation of the ML model. Therefore, eliminating the need of having the data wrapper at the time of inference of the ML model by converting the transformation metadata to performant code may improve the ML model inference performance.

FIG. 4 is a high-level workflow 400 of converting metadata into low latency code, in accordance with some embodiments of the present disclosure.

According to some embodiments of the present disclosure, raw data may be read, and transformations may be captured in the model builder pipeline by reading the transformation-metadata and defining the model feature transformations 410.

According to some embodiments of the present disclosure, a converter utility, such as metadata converter tool, may take the model pipeline and extract the transformation-metadata 415.

According to some embodiments of the present disclosure, the transformation-metadata 420 may be for example,
BlockName, VarName, Condition, True.Value, False.Value, Type
Enrich,trxAmountCurrency_IS_MISS,missing(input_df$transactionAmountCurrency),True, False,

According to some embodiments of the present disclosure, a parser utility may parse the transformation-metadata 420 and may extract the details and create in memory metadata objects 430.

According to some embodiments of the present disclosure, for example,

```
{{
{
      “blockName”: “Enrich”,
    “VarName”: trxAmountCurrency_IS_MISS”,
“Condition”: “missing(input_df$transactionAmountCurrency)”,
      “True.Value”: 999,
  “False.Value”: transactionsAmountCurrency,
      “Type”: Int
}
}}
```

According to some embodiments of the present disclosure, by using reference function mapping 435 the utility may identify the corresponding Python® function for that transformation-metadata and may generate the high performant Python® code. For example,
“missing”: “TransformUtill.missing”
“substr”: TransformUtil.subStrFromInd1”
“as.date”: TransformUtil.as_Date”

According to some embodiments of the present disclosure, utility to generate low latency code 440 may identify corresponding programming language component, such as Python® component using reference mapping for each element and then, generate high performant program language 445, such as Python® code.

FIG. 5 schematically illustrates a software design 500 for automated deployment for containerized model, in accordance with some embodiments of the present disclosure.

According to some embodiments of the present disclosure, a software utility, such as automated utility to push model image to repository 510 may enable the users of Jupyter notebook, such as users 105 in FIG. 1, to push the containerized model image 505, that includes model artifacts 145 in FIG. 1 and low latency feature transformation code 125 in FIG. 1, for the low latency model, such as containerized model 160 in FIG. 1, to a software artifacts repository, such as Amazon® Web Services (AWS) Elastic Container Registry (ECR) or JFrog Artifactory 520.

According to some embodiments of the present disclosure, the model image repository 525 within the artifacts repository 520 maintains the versioning, as well as tagging for the containerized model image. The container model image of the containerized model, such as containerized model 160 in FIG. 1, which has been developed, e.g., using the Jupyter notebook, may be pushed into a model repository with a tag. The tag may indicate name or type or version and the like which is associated to the ML model and can uniquely identify the container model image.

According to some embodiments of the present disclosure, the Helm chart repository 530 of the artifact repository may store the files for Helm chart. The Helm chart is used for defining, installing, and upgrading Kubernetes applications. The Kubernetes application creates a software ecosystem by making use of the containerized model image. Helm chart also configures the hardware and other resources required to run the container model image.

According to some embodiments of the present disclosure, Continuous Integration/Continuous Deployment (CI/CD) software tools automate the process of integrating code changes, running automated tests, and deploying applications to various environments. These tools streamline the software delivery pipeline. A Jenkins CI/CD server 540 may operate an automated image pulling software agent 545 to pull the model container image from the model image repository 525 and passing it to the image deployment utility, such as automated image deployment image 555. The Jenkins CI/CD server 540 may operate an automated Helm Chart pulling software agent 550 to pull the Helm chart from the Helm chart repository 530 and pass it to image deployment utility 555.

According to some embodiments of the present disclosure, the image deployment utility 555 may leverage the kubectl software component 560, which is a command-line tool used to interact with Kubernetes clusters such as Kubernetes cluster 565, to perform the deployment process of the containerized model image to the Kubernetes cluster 565. The Kubernetes cluster 565 deploys the container image as a pod.

According to some embodiments of the present disclosure, the deployment process of the model container image 505 to the Kubernetes cluster 565 using Kubectl utility may include the necessary steps to authenticate with the Kubernetes cluster 565 and execute the kubectl utility commands for deployment. This process also includes configuring Kubernetes credentials, setting up Jenkins pipeline, authentication with Kubernetes cluster 565, and deployment to the Kubernetes.

According to some embodiments of the present disclosure, the control plane 570 for the Kubernetes cluster 565 may include components which are responsible for managing the worker nodes 580a-580b and the workloads, e.g., pods, which are running on them. It acts as the central command center, ensuring that the cluster runs smoothly and efficiently. The control plane 570 maintains the cluster state, issue commands to the nodes, schedule workloads, self-healing and the like.

According to some embodiments of the present disclosure, in a Kubernetes cluster, a node in the cluster, such as node 580a and node 580b is a worker machine. It executes the containerized applications, e.g., the containerized ML model, such as containerized ML model 160 in FIG. 1. The node 580a is comprised of major components like Kubelet, container runtime, Kube-proxy etc. The model POD inside the node 580a executes the low latency transformation using the native programming language, such as Python® to achieve the response in a reduced latency e.g., latency of lower than 10 milliseconds.

According to some embodiments of the present disclosure, during its operation, the IFM system 585 may calculate the risk score while processing a financial transaction by sending a request to the Kubernetes cluster 565 using the Kubectl component 580a. In response to the request, the IFM 585 may receive the risk score for the transaction by using the node 580b. The risk score may be created by the container model inference for each request.

According to some embodiments of the present disclosure, upon receiving a risk score above a preconfigured threshold, the IFM system 585 may not approve the transaction and may put the transaction on-hold for further review.

FIG. 6 is a high-level workflow of real-time model inference for fraud detection 600, in accordance with some embodiments of the present disclosure.

According to some embodiments of the present disclosure, the real-time transaction or current activity information that identifies the type of interaction of the customer with the account, the device used for performing the activity, the funds value requested for transfer for monetary transaction, and the like may be initially captured in the core banking system 610 of the financial institute.

According to some embodiments of the present disclosure, a core banking platform for a financial institution 610 handles the majority of the bank's critical functions. These functions include managing customer accounts, processing transactions, maintaining customer records, and ensuring regulatory compliance. The core banking system 610 is essential for the bank's operations, supporting daily banking activities and enabling the provision of various financial services to customers.

According to some embodiments of the present disclosure, a transaction received in the core banking platform 610 may be forwarded to the IFM system 685, such as IFM system 585 in FIG. 5, for detecting the risk pertaining to any fraud related to the transaction. The IFM system 685 may receive the transaction with the data associated with the transaction and parties involved in the transaction.

According to some embodiments of the present disclosure, the IFM system 685 may detect, prevent, and manage fraud across multiple channels and financial products within financial institutions.

According to some embodiments of the present disclosure, to detect fraud in financial transactions, the IFM system 685 relies on the risk score calculated by a machine learning model. The IFM system 685 sends the data of the transaction to the Kubernetes cluster 665, such as Kubernetes cluster 565 in FIG. 5, where the containerized ML model is hosted. For example, a request that the IFM system 685 may send to the ML Model that is hosted on Kubernetes cluster 665 to get the risk score may be:

```
{
  “records”: [
    {
      “id”: “123455”,
      “fields”: {
          “accountOpeningDate”:“02-02-2023”,
          “transactionDate”:“12-05-2023”,
          “first_transactionAmount”:220,
          “averageTransactionAmount”: 150,
          “currentTransactionAmount”: 5000
        }
    }
  ]
}
```

According to some embodiments of the present disclosure, the Kubernetes cluster 665, such as Kubernetes cluster 565 in FIG. 5, may host the containerized ML model, such as containerized ML model 160 in FIG. 1 and such as containerized model image 505 in FIG. 5. A Kubernetes cluster is a set of node machines for running containerized applications, managed by the Kubernetes system. Kubernetes, is an open-source platform designed for automating the deployment, scaling, and operations of application containers across clusters of hosts, providing container-centric infrastructure. A Kubernetes cluster simplifies the management of large-scale applications, enabling efficient utilization of resources, high availability, and seamless scaling, making it a popular choice for modern cloud-native applications. The Kubernetes cluster 665 in the IFM system 685 uses nodes, such as nodes 580a and 580b in FIG. 5 that include model pods, hosts the containerized ML model. A model pod represents a single instance of a running process in the cluster, e.g., ML model.

According to some embodiments of the present disclosure, the model pod 680 in the Kubernetes cluster 665 may receive the raw features of the transaction for which the risk score is required to be calculated to determine the probability of that transaction being a fraudulent transaction. There can be multiple raw features associated with each transaction that the IFM system 685 is required to score. Some of the raw features may be extracted from the database of the IFM system.

According to some embodiments of the present disclosure, the ML model may require certain derived features for its operation to calculate the risk score. Each derived feature may be created by performing some mathematical operations on one or more of the raw features. A subset of raw features may be fed into the programming language code, e.g., Python® code to transform the raw features into the derived features.

According to some embodiments of the present disclosure, the created low-latency feature transformation code 650 may take the subset of raw features as input and emit the derived features which are required for calculating the risk score by the ML model. The low-latency feature transformation code ensures that the risk-score for the transaction is feasible to calculate in reduced latency such as in single digit milliseconds. The low latency code executing inside the containerized ML model may be in either Python® or other programming languages such as Java.

According to some embodiments of the present disclosure, the derived features 620 which were created from the low latency transformation code 650 may be combined with the raw features and forwarded to the ML model object 630.

According to some embodiments of the present disclosure, the model invoker 630 may combine the raw features and derived features and may forward it to the ML model object 645. The ML model object 645 may take the raw features and the derived features values as input. These feature values are used by the ML model objects to calculate the risk-score which is a prediction score. The ML model object 645 may return the risk score which is a probability of the transaction in question being fraudulent.

According to some embodiments of the present disclosure, the risk score 640 may be returned from the model pod 680 in the node, such as node 580 in FIG. 5 on the Kubernetes cluster 665, to the other component of the IFM system 685.

According to some embodiments of the present disclosure, the risk score may be returned to the components of the IFM system 685. The risk score may be used by the other IFM components in the further transaction processing. A response that ML Model hosted on Kubernetes cluster 665 may send to the IFM system 685 may be, for example,

```
{
  “records”: [
    {
      “id”: “123455”,
      “fields”: {
        “prediction_score”: 0.789
      }
    }
  ]
}
```

According to some embodiments of the present disclosure, the IFM system 685 may persist the risk-score for the transaction into the IDB database 675. The risk score may be added to the current enriched real-time activity and the activity data may be passed to the policy manager rule engine 660 for evaluation of the strategy rules that decide on the alerting of the transaction and prescribed next steps based on the strategy rules which are evaluated as affirmative. The transaction risk score along with the indication of alert and prescribed next steps may be wrapped in response and sent back to the IFM 685 from where the real-time activity information was passed for detection.

According to some embodiments of the present disclosure, based on the outcome from the policy manager rules evaluation, the transaction is marked for rejection, approval or hold. That response is relayed back to the core banking platform 610. The user for the real time transactions gets the response for the carried-out transaction accordingly.

According to some embodiments of the present disclosure, optionally, the transaction may be automatically rejected, approved or put on hold based on a preconfigured threshold of the calculated risk-score.

According to some embodiments of the present disclosure, in addition to relaying the alert for rejected or on-hold transactions to users, the IFM system 685 may also persist the alert information on the Alert database 625.

According to some embodiments of the present disclosure, the alert investigators at the financial institute may investigate the alerts using the User Interface (UI) of the financial crime management system 635. The fraud analysts may assess the risk-score, and other parameters associated with the party as well as transaction for investigating the suspected fraudulent transactions.

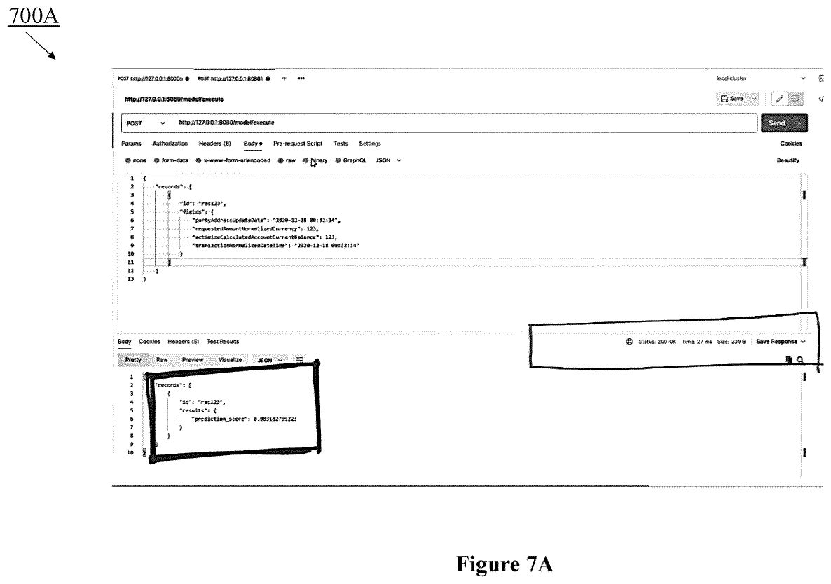

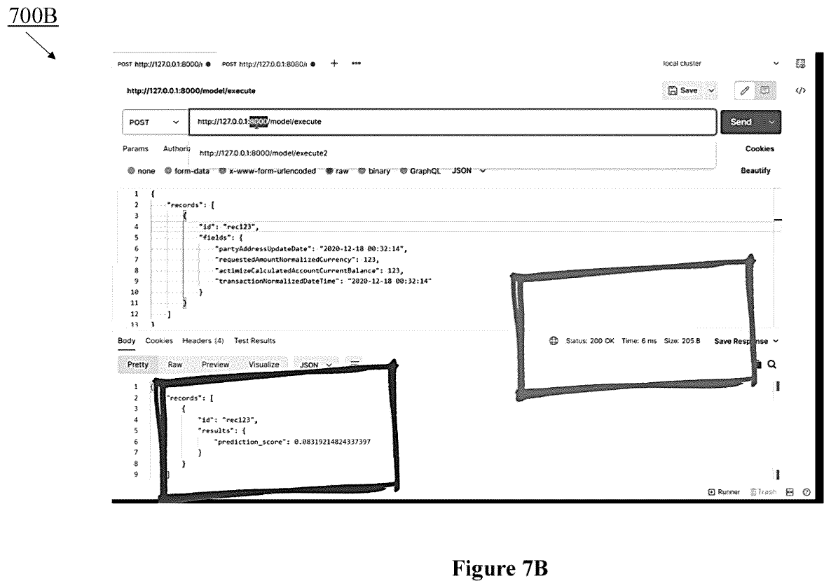

FIG. 7A is a screenshot 700A of an Application Programming Interface (API) testing tool showing a calculated score and time required to calculate it, in accordance with some embodiments of the present disclosure.

According to some embodiments of the present disclosure, for simulation purposes, an ML model has been created by using a training dataset. The transformations for the derived features have been kept in native data wrappers, e.g., Pandas. Subsequently, the ML model was containerized and hosted on a computer with 4 CPU cores and 32 GB RAM. The response time for the inference calculated from the ML model, the latency for ML model inference has been about 27 milliseconds for a sample transaction.

FIG. 7B is a screenshot 700B of an Application Programming Interface (API) testing tool showing a calculated score and time required to calculate it, in accordance with some embodiments of the present disclosure.

According to some embodiments of the present disclosure, making use of the same training dataset, another ML model has been created. The transformation metadata for the derived features has been converted from CSV to Python® code. The ML model object has been packaged along with the Python® code for the transformations. The ML container image that has been created, such a containerized model 160 in FIG. 1, has been hosted using a computer with 4 CPU cores and 32 GB RAM. The same request that was used that yielded screenshot 700A, has been used for getting the inference from the created ML model container. The prediction score is identical to the prediction score in screenshot 700A, whereas the latency has been reduced to one-digit milliseconds, e.g., 6 milliseconds.

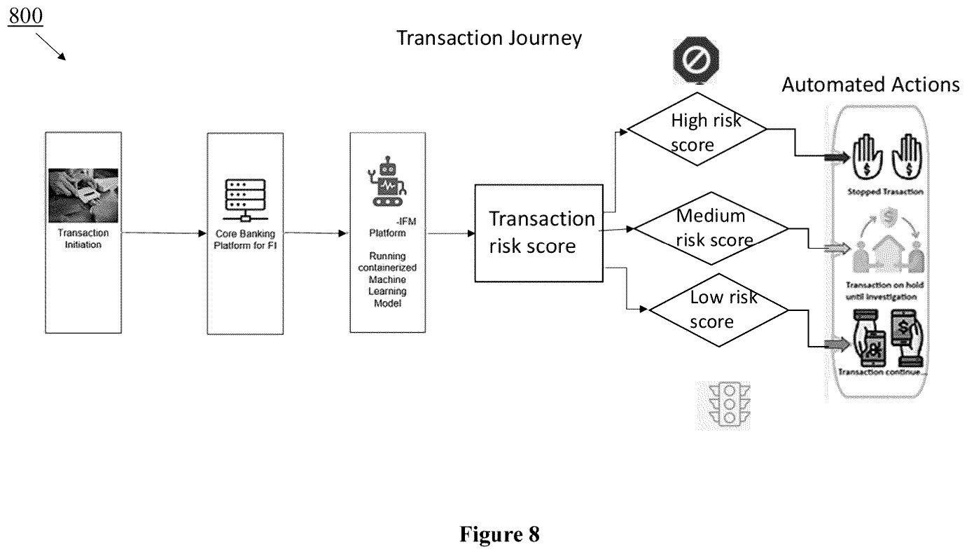

FIG. 8 illustrates a transaction journey in a process of fraud detection, in accordance with some embodiments of the present disclosure.

According to some embodiments of the present disclosure, a financial institute needs to process several types of transactions for the customers. These transactions can be of monetary or non-monetary types. The transactions may be for example, a customer swiping the credit card on card reader machine to make the payment, customer login to internet banking to check the balance on account etc.

According to some embodiments of the present disclosure, these transactions are processed via the core banking platform system that is implemented. The core banking platform for a financial institution (FI), such as financial institute's core banking system 610 in FIG. 6, is a centralized system that handles the majority of the bank's critical functions. These functions include managing customer accounts, processing transactions, maintaining customer records, and ensuring regulatory compliance. The core banking system is essential for the bank's operations, supporting daily banking activities and enabling the provision of various financial services to customers.

According to some embodiments of the present disclosure, the transaction is being passed to the IFM system, such as IFM system 685 in FIG. 6, for detecting the risk pertaining to any fraud for the transaction. The IFM system is passed with the data associated with the transaction and parties involved in the transaction. The IFM system is a comprehensive solution designed to detect, prevent, and manage fraud across multiple channels and financial products within financial institutions. For detecting fraud in financial transactions, IFM system relies on the risk score calculated by a machine learning model.

According to some embodiments of the present disclosure, output of the predictive algorithms is probability score which is also referred as risk score or rule score. Scores are arranged in descending order to rank. Alerts associated with only high rank are sent for the further investigation.
Predictive algorithms->risk score {0.0 . . . 1.0} higher the score riskier the transaction of the customer is. Further investigation needs to be done.

According to some embodiments of the present disclosure, there are automated actions that get triggered based on the value for the risk score. Consequently, the transaction undergoes one of the following response within a reduced latency e.g., few millisecond latency.

According to some embodiments of the present disclosure, the automated actions that may be triggered are for example:
Stopped Transaction: If the risk score is greater than or equal to the configured threshold value, the transaction may be stopped entirely to prevent potential fraud.
On Hold: If the risk score falls between the Predictive Escalation Threshold and the Hibernation Threshold, the alert is routed to the Standard Queue. This signifies medium priority, and the transaction may be put on hold for further investigation.
Approved Transaction: If the risk score for the transaction is low, the transaction can continue as usual.

According to some embodiments of the present disclosure, the Stopped or On-Hold transactions may be displayed to the alert investigators at the financial institute which investigates the alerts. The fraud Analysts, e.g., alert investigators, assess the risk-score and other parameters associated with the party as well as transaction for investigating the suspected fraudulent transactions.

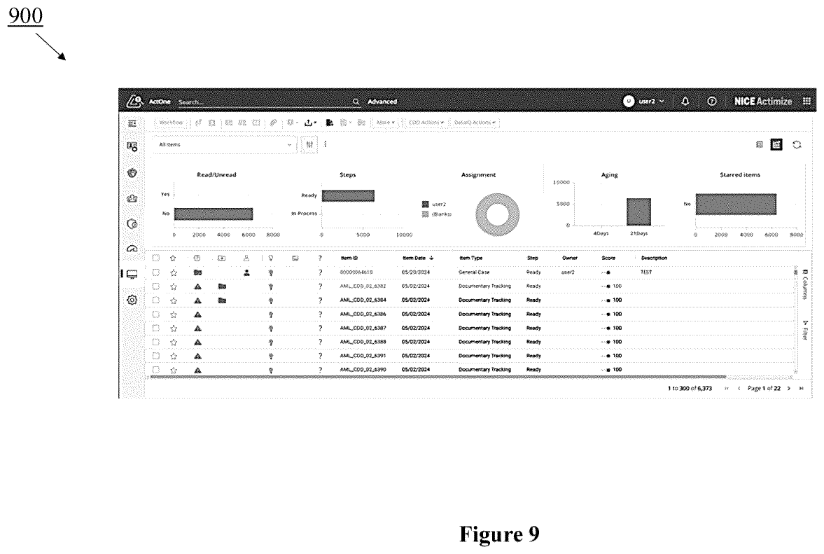

FIG. 9 is a screenshot 900 of a UI displaying a list of alerts, in accordance with some embodiments of the present disclosure.

According to some embodiments of the present disclosure, a fraud analyst may investigate the fraud alerts for suspicious fraudulent transaction.

According to some embodiments of the present disclosure, each alert may be displayed with the risk score calculated by the ML model.

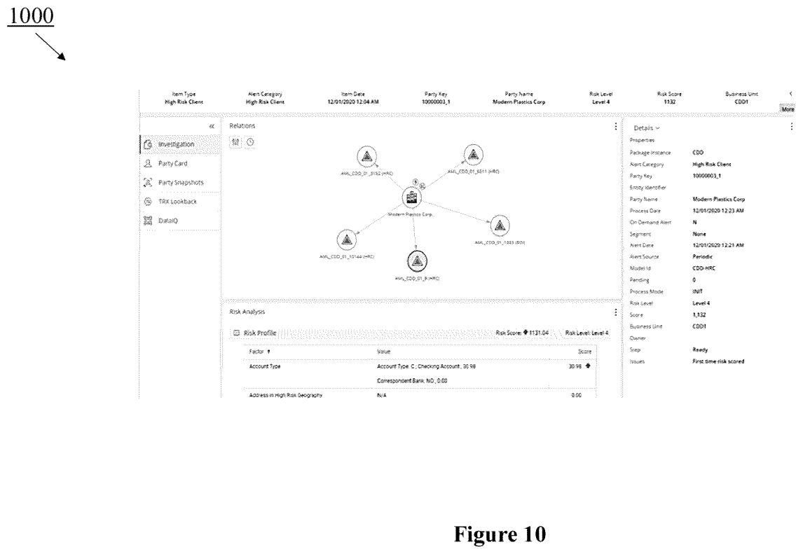

FIG. 10, a screenshot 1000 of a UI displaying details of an alert, in accordance with some embodiments of the present disclosure.

According to some embodiments of the present disclosure, screenshot 1000 displays the details of a specific fraud alert.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for reducing inference latency of a containerized Machine Learning (ML) model, said computerized-method comprising:
(i) training an ML model on a plurality of raw features which are stored in a feature database and a plurality of derived features, and creating a trained ML model object;
(ii) operating transformation metadata extraction for each derived feature in the plurality of derived features to generate a transformation-metadata file, wherein said transformation-metadata file includes transformation-metadata;
(iii) converting the transformation-metadata in the transformation-metadata file to a programming language code to yield a performant code;
(iv) executing the performant code by the trained ML object to generate derived features;
(v) packaging the trained ML model object and the yielded performant code by operating a model containerization service to create an ML model container image of the containerized ML model to be stored in a container registry; and
(vi) configuring a platform that provides a model-hosting-service to run the ML model container image and apply the performant code on features in a request from a features management-platform to provide a calculated score to the features management-platform.

2. The computerized-method of claim 1, wherein said transformation metadata extraction comprising:
(i) selecting raw features from the plurality of raw features;
(ii) determining one or more feature-calculations on the selected raw features to create derived features, wherein the one or more feature-calculations are the transformation metadata for the raw feature; and
(iii) generating the transformation-metadata file with the determined one or more feature-calculations on the selected raw features.

3. The computerized-method of claim 1, wherein said calculated score is a risk score of a financial transaction, and wherein said features management-platform is a fraud risk management-platform.

4. The computerized-method of claim 1, where said platform that provides model hosting service is one of: cloud services, managed container services and Kubernetes cluster, and wherein said containerized ML model image is deployed as a pod in the Kubernetes cluster.

5. The computerized-method of claim 2, wherein the calculating of the score is operated by the trained ML object by using the selected raw features and the created derived features.

6. The computerized-method of claim 3, wherein said fraud risk management-platform invokes the ML model container image to run during a financial transaction processing.
